(19) United States
(12) Patent Application Publication
(10) Pub. No.: US 2010/0026305 A1
(43) Pub. Date: Feb. 4, 2010

(54) Method and Apparatus for Imaging Boreholes

(75) Inventor: Carlos A. Yanzig, Houston, TX (US)

Correspondence Address: MADAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 12/183,809

(22) Filed: Jul. 31, 2008

(51) Int. Cl. G01V 3/20

(52) U.S. Cl. 324/355

(57) ABSTRACT

A method and apparatus for imaging wellbores is provided that in one aspect may include inducing an electrical signal into a formation, receiving a current signal responsive to the induced electrical signal by at least one measure electrode placed in a pad disposed in the wellbore, generating an impedance signal in response to the received current signal using a receiver circuit placed in the pad and coupled to the at least one measure electrode and providing an image of the wellbore wall using the impedance signal.

### BACKGROUND OF THE DISCLOSURE

1. Field of the Disclosure

The disclosure herein relates generally to downhole electrical tools and methods for providing borehole images.

2. Background Information

Electrical logging is commonly used for evaluating earth formations for the purpose of producing hydrocarbons (oil and gas) therefrom. One type of electrical logging tool is used to image boreholes. Such tools typically include one or more pads that extend to contact the borehole wall. Each pad generally includes a plurality of measure electrodes and guard electrodes. The measure electrodes are insulated from each other and from the guard electrodes. In such a tool, current from the plurality of measure electrodes is induced into the formation surrounding the borehole. The induced current from each measure electrode varies, based on the resistivity of the borehole wall area covered by the measure electrode. In another type of electrical logging tool, the pads include a plurality of measure electrodes and transmitter electrodes. A low voltage, high frequency signal is introduced in a formation via the transmitter electrodes. Current received by each measure electrode is measured. The measured (or survey) signals from the measure electrodes are forwarded to a processing circuit placed in the tool body, which is typically between two and four feet from the measure electrodes. Such a distance often attenuates the survey signals, deteriorating the quality of the survey signals. The circuits in the tool determine the impedance values from the survey signals. One or more processors utilize the determined impedance values and estimated phase values to provide images of the borehole wall.

The disclosure herein provides an improved electrical image logging tool that mitigates the effects of the attenuation of the survey signals and further utilizes measured phase values for providing images of resistivity of the earth formation (or borehole images).

### SUMMARY OF THE INVENTION

In one aspect, the disclosure herein provides an apparatus for estimating a property of a formation. One embodiment of the apparatus may include: a transmitter configured to induce an electrical signal into the formation, at least one measure electrode on a pad configured to provide a current signal in response to the electrical signal induced into the formation, and a receiver circuit in the pad configured to provide a signal (or impedance signal) representative of the impedance of the formation in response to the current signal provided by the measure electrode. The impedance signal includes module and phase signals.

In another aspect, a method is provided that may include: inducing an electrical signal into a formation, receiving a current signal in response to the induced electrical signal into the formation by at least one measure electrode placed in a pad disposed in the borehole, and generating an impedance signal [module and phase signals] in response to the received current signal using a receiver circuit placed in the pad and coupled to the at least one measure electrode.

### BRIEF DESCRIPTION OF THE DRAWINGS

The present disclosure is best understood with reference to the accompanying figures in which like numerals generally refer to like elements and wherein:

FIG. 1 shows an exemplary borehole imaging tool suspended in a borehole that includes a plurality of pads, each pad including a plurality of measure electrodes and measuring circuits made according to one embodiment of the disclosure;

FIG. 2 shows certain details of the earth imaging tool shown in FIG. 1;

FIG. 3 is a top view of an exemplary pad for use in the tool shown in FIG. 2 according to one embodiment of the disclosure;

FIG. 4 is an exemplary circuit that includes a gain/phase analyzer that may be placed in the pad and coupled to each measure electrode for providing the impedance signals [module and phase] for each measure electrode; and

FIG. 5 shows an exemplary printed circuit board layout of certain components of the circuit shown in FIG. 4 for placement in a pad, such as the pad shown in FIG. 3, according one exemplary embodiment.

### DETAILED DESCRIPTION OF THE DRAWINGS

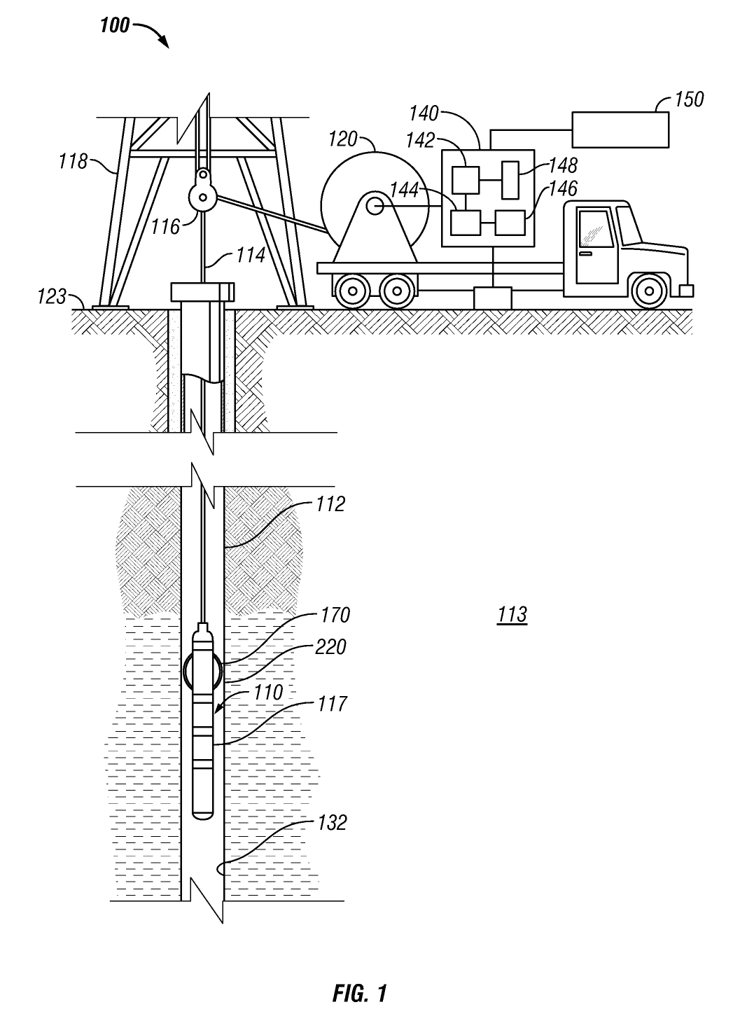

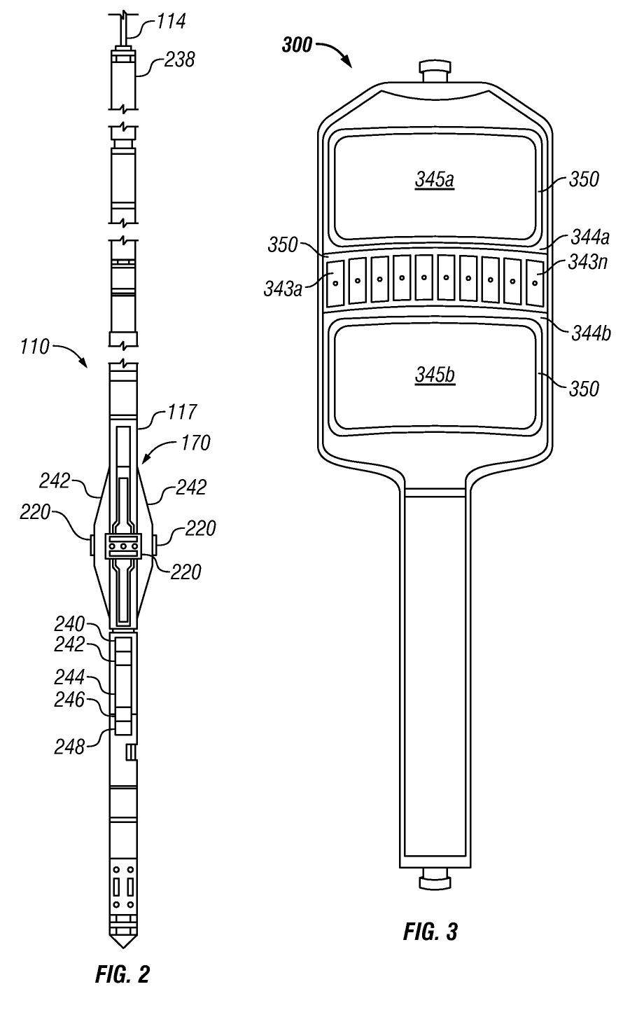

FIG. 1 shows a well logging system 100 that includes an electrical imaging logging tool 110 (also referred to herein as “tool”) shown suspended in a borehole (or wellbore) 112 penetrating an earth formation 113 from a suitable conveying member 114. The conveying member 114 may be a wireline cable, coiled tubing or slickline. The tool 110 may be raised and lowered by a draw works 120. A suitable mechanism, such as a sheave 116, mounted on a rig 118 disposed at the surface 123 may be utilized to raise and lower the logging tool 110. When the conveying member 114 is a wireline cable, it includes a number of conductors (typically seven) for providing two-way data communication between a surface controller 140 and the tool 110 as well as for providing electrical power from the surface to the tool 110. The controller 140 (also referred herein as the “surface controller” or the “surface control unit”) may be a computer-based unit. The control unit 140 may include a processor 142, a suitable data storage device 144 (including, but not limited to, a solid state memory, hard disk, and magnetic tape), for storing data and computer programs 146 for use by the processor 142. Any suitable display device 148, such as a monitor, may be provided to display images and other data during logging of the borehole 112. During logging operations, the controller 140 transmits operating instructions or commands to the tool 110, receives data from the tool and processes the data in accordance with the instruction in the program 146. The controller 140 may store any or all of the processed data, display the results, including images of the borehole and send such information to a remote unit 150 for further processing. In one aspect, the tool 110 includes a plurality of arms 170 that are configured to extend outward from the tool body 117. In one aspect, each arm 170 includes a pad 220 that is made according to one of the embodiments of this disclosure, as described in more detail in reference to FIGS. 2-6.

FIG. 2 is a schematic external view of the tool 110, which is shown to include a number of azimuthally placed arms 170 that are configured to extend outward from the tool body 117. Each arm 170 is shown to include a pad 220 that, in one aspect, is configured to contact the borehole inside 132 (FIG. 1). The number of pads is arbitrary and in general may vary between 4-6 pads so as to obtain substantially full coverage of the borehole inside 132. The tool 110 further may include a control unit 240 for controlling the operations of the tool 110 and for establishing two-way communication with the surface control unit 140. The control unit 240 may includes a processor 242, data storage device 244 and computer programs, and other data 246 for use by the processor 242 to process measurements made by the tool 110 in accordance with the instructions in the program 246 and instructions transmitted by the surface controller 140. The control unit 240 may further include additional circuitry 248. The control unit may be placed at any suitable location in the tool 110. The upper portion of the tool 110 is shown to contain a telemetry module 238 which transmits data from the tool 110 to the surface control unit 140 and receives data from the surface for use by the control unit 240.

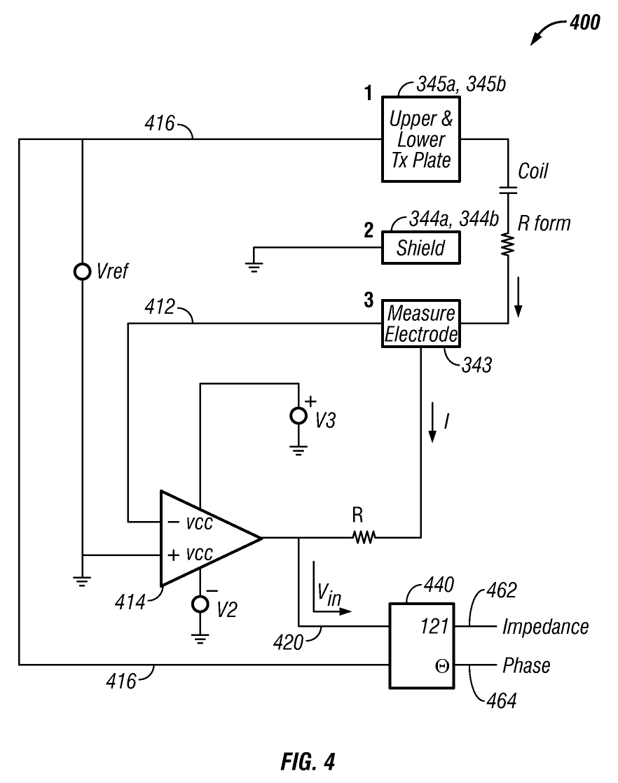

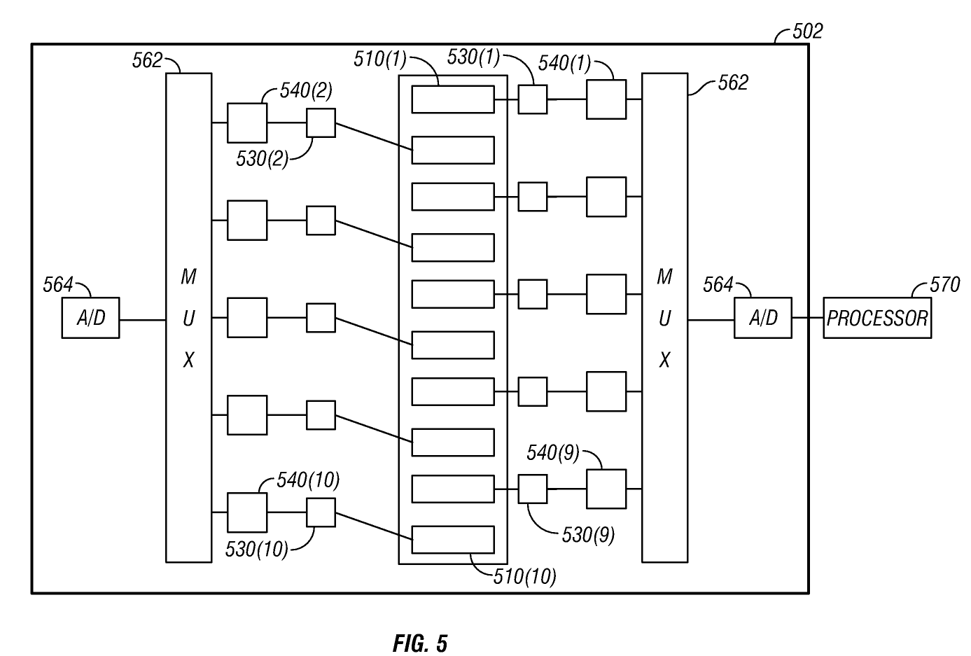

FIG. 3 shows a top view of the pad 220 made according to one embodiment of the disclosure. The pad 220 is shown to include a number of measure electrodes (also referred to as “buttons”) 343a, 343b, . . . 343n placed on a pad member 340. An upper transmitter electrode 345a and a lower transmitter electrode 345b are placed on two opposing sides of the measure electrodes. Alternatively, a single transmitter electrode may be utilized. Shields 344a and 344b surround the measure electrodes and the transmitter electrodes. Insulators 350 insulate the measure electrodes from each other, shield from the measure electrodes and the transmitter electrodes from the shield and the measure electrodes. Typically, the measure electrodes are placed close to each other in one or more rows so as to cover substantially all the contiguous radial region of the borehole wall spanned by the measure electrodes. The operation of the tool 110 and the various circuits used in relation to the various electrodes on the pad 340 are described below in reference to FIGS. 4 and 5.

FIG. 4 shows a schematic diagram of an electrical circuit for use with the measure electrodes in each pad, according one aspect of the disclosure. A reference voltage V_{ref} is applied to the upper and lower transmitter electrodes 445a and 445b. This induces a voltage signal the formation proximate the transmitter electrodes. R_{form} is a representation of the formation resistivity, while Cₒᵢₗ represents the capacitance due to the oil-based mud in the borehole 112. Typically, the voltage source supplies relatively low voltage (between 1-5 volts) signals at a relatively high frequency (between 100 kHz to 10 MHz). Any other suitable values of the voltage and frequency may also be utilized. Furthermore, the frequency may be variable.

FIG. 4 shows the use of the circuit 400 for a generic measure electrode designated by numeral 343. When V_{ref} is applied to the transmitter electrodes 345a and 345b, current “I” will flow through the formation 132 to the measure electrode 343. The measure electrode 343 is coupled to an operational amplifier 414 via line 412 on one side and via a suitable resistor R on the other side. During operation of the tool 110, measure electrode 343 and the shields 344a and 344b are held at virtual ground. A gain/phase analyzer (also referred to as an impedance and phase circuit) 440 is coupled to an end 418 of the operational amplifier 414 and the V_{ref} via line 416. When the V_{ref} is applied to the transmitter electrodes 345a and 345b, a current loop is formed between the transmitter electrodes 345a and 345b and the measure electrode 343 via the formation 132 as shown by loop I. In the absence of V_{ref} on the transmitter electrodes 345a and 345b, no or very little current flows through the measure electrode 343 due to the presence of the resistor R, which typically maybe around 1K ohms. During operation of the tool, the voltage Vin (proportional to Current I) is one input to the gain/phase analyzer 440 (or receiver circuit). The gain/phase analyzer provides a DC voltage value 462 (representative of the impedance module) as one output and phase 464 as the second output. The current I flowing through the measure electrode 343 will depend upon the impedance of the formation adjacent the measure electrode 343, which may vary as the tool passes along the borehole 132. In practice, a separate gain/phase analyzer 440 may be coupled to each measure electrode 343a-343n so that the module and phase signal outputs at each measure electrode are generated during logging of the wellbore 112 (i.e., in-situ). The impedance module and phase signals provided by each gain/phase analyzer 440 may be digitized by an analog-to-digital (A/D) converter on the pad or at another suitable location on the tool and then processed by a processor, such as the processor 142 and/or 242 to provide data relating to the resistivity of the formation and/or an image of the borehole 120 as described later.

FIG. 5 shows an exemplary layout of certain components of the circuit 400 on a printed circuit board 502, which printed circuit board may be placed in the pad 220 so that such components are proximate to their corresponding measure electrodes 343a, . . . , 343n to mitigate the effects of attenuation and to provide measurement for both the impedance and the phase corresponding to the currents flowing through each of the measure electrodes. As an example, FIG. 5 shows ten measure electrodes 510(1)-510(10) arranged in a single row. Each measure electrode 510(1) through 510(10) is coupled to a corresponding operational amplifier 530(1)-530(10). For example, the measure electrode 510(1) is shown coupled to the operational amplifier 530(1) while the measure electrode 510(10) is shown coupled to the operational amplifier 530(1). Each operational amplifier 530(1)-530(10) is then coupled to a corresponding gain/phase analyzer 540(1)-540(10). A common multiplexer 562 coupled to each of the gain phase analyzers may be placed on the printed circuit board 502. An A/D converter 564 may also be placed on the printed circuit board 502.

In one aspect, the printed circuit board 502 is placed below the measure electrodes on the pad and is sealed from the outside environment. Any suitable method of attaching the components on the printed circuit board to the measure electrodes may be utilized. Further, any other suitable layout of the printed circuit board 502 may be used for placing the gain/phase analyzers in the pad and close to their corresponding measure electrodes. Any other suitable method or assembly may also be used to place the gain/phase analyzers in the pad. In one aspect, a commercially available gain/phase analyzer AD8302 made by Analog Devices Inc. may be used for the purpose of this disclosure.

As noted above, the phase signals from each measure electrode 343a through 343n may be passed to the controller 240 (FIG. 2) for processing of such signals according to the programs 246 and/or instructions provided by the surface controller 140. The controller 140 and/or 240 processes the signals provided by the various circuits in the tool 110, and provides resistivity values corresponding to each measure electrode 343a through 343n in the tool 110. The processor also may be configured to provide visual images of the resistivity of the formation as a function of the borehole depth. The image may be used to identify formation anomalies, such as cracks, gauges, etc. in the borehole wall.

Thus, the disclosure herein, in one aspect, provides an apparatus for estimating a property of a formation, which apparatus may include: a transmitter configured to induce an electrical signal into the formation surrounding the wellbore; at least one measure electrode on a pad configured to provide a current signal in response to the electrical signal induced into the formation; and a receiver circuit in the pad, wherein the receiver circuit provide an impedance signal (comprising an impedance module signal and a phase signal) in response to the current signal. The apparatus may further include a processor configured to process module signal (first output signal) and the phase signal (second output signal) to provide an estimate of the property of the formation. In one aspect, the property of the formation is resistivity of the formation. In one aspect, the apparatus may include a plurality of measure electrodes on the pad and the receiver circuit may include a separate gain/phase circuit associated with each measure electrode to provide the impedance module and phase signals corresponding to its associated measure electrode. In one aspect, each gain/phase circuit is an integrated circuit that is embedded in the pad.

In another aspect, the transmitter of the apparatus may include: at least two transmitter electrodes spaced apart from the measure electrode and a circuit that provides a selected voltage at a selected frequency to the at least two transmitter electrodes. In one aspect, an analog to digital converter may be provided on the pad that is configured to digitize the impedance module and phase signals. In another aspect, the apparatus may also include a multiplexer on the pad that is configured to sequentially select signals from each of the gain/phase circuits and provide the selected output signals to the analog-to-digital converter. In another aspect the tool may include a plurality of azimuthally spaced apart pads, each pad including one or more measure electrodes to provide a substantially full coverage of the wellbore. In another aspect, the processor of the apparatus may provide a visual image of the borehole wall using the estimated property of the formation.

In another aspect, a method is provided that may include: inducing an electrical signal into a formation; receiving a current signal responsive to the induced electrical signal by at least one measure electrode placed in a pad disposed in the wellbore; and generating an impedance signal and a phase signal in response to the received current signal using a receiver circuit that is placed in the pad and coupled to the at least one measure electrode. The method may further provide an estimate of a property of the formation using the impedance and phase signals. In one aspect, the property of the formation may be resistivity of the formation.

In another aspect, the method may include the use of a plurality of measure electrodes and a separate gain/phase circuit associated with each measure electrode that provides an impedance signal and a phase signal corresponding to its associated measure electrode. Each gain/phase circuit may be an integrated circuit that is embedded in the pad. In the method, inducing an electrical signal into the formation may include inducing a voltage signal having a selected voltage at a selected or varying frequency via at least two electrodes placed spaced apart from the at least one measure electrode on the pad. The impedance signals may be provided as a DC voltage signal, which may be digitized by an analog-to-digital circuit placed in the pad. In another aspect, the method may further include processing the impedance signal and the phase signal to provide an image of a wall of the wellbore.

The term processor is used herein in a broad sense and is intended to include any device that is capable of processing data relating to the system 100, including, but not limited to: microprocessors, single-core computers, multiple-core computers, distributed computing systems and field programmable gate arrays (FPGAs). The data storage device or the machine-readable medium referenced in this disclosure may be any medium that may be read by a machine and it may include, but is not limited to, magnetic media, RAM, ROM, EPROM, EAROM, flash memory, hard disks and optical disks. The processing may be performed downhole or at the surface. Alternatively, part of the processing may be performed downhole with the remainder processing performed at the surface.

While the foregoing disclosure is directed to the certain embodiments, various modifications and variations will be apparent to those skilled in the art. It is intended that all such modifications and variations are within the scope of any claims that are or may be made relating to the foregoing disclosure.

What is claimed is:

1. An apparatus for estimating a property of a formation, comprising:
a transmitter configured to induce an electrical signal into the formation;
at least one pad containing at least one measure electrode configured to provide a current signal responsive to the induced electrical signal; and
a receiver circuit in the pad configured to provide an impedance signal responsive to the current signal.

2. The apparatus of claim 1, wherein the impedance signal comprises a module signal and a phase signal and wherein the processor is further configured to process the module signal and the phase signal to provide an estimate of the property of the formation.

3. The apparatus of claim 1, wherein the property of the formation is resistivity of the formation.

4. The apparatus of claim 1, wherein:
the at least one measure electrode comprises a plurality of spaced apart measure electrodes in the pad; and
the receiver circuit comprises a separate gain/phase circuit electrically coupled to an associated measure electrode.

5. The apparatus of claim 4, wherein each gain/phase circuit is an integrated circuit in the pad.

6. The apparatus of claim 1, wherein the transmitter comprises:
at least one transmitter electrode in the pad spaced apart from the at least one measure electrode; and
a voltage source that provides a selected voltage at a selected frequency to the at least one transmitter electrodes for inducing the signal into the formation.

7. The apparatus of claim 2 further comprising an analog-to-digital converter on the pad that is configured to digitize the module signal and the phase signal provided by each gain/phase circuit.

8. The apparatus of claim 7 further comprising a multiplexer on the pad that is configured to sequentially select the module signal from each of the gain/phase circuits and provide the selected module signal to the analog-to-digital converter.

9. The apparatus of claim 1, wherein the at least one pad includes a plurality of azimuthally-spaced pads to provide a substantially full coverage of the wellbore.

10. The apparatus of claim 1, wherein the processor is further configured to provide a visual image of the estimated property of interest as a function of a borehole depth.

11. A method of estimating a property of a formation surrounding a borehole, the method comprising:
inducing an electrical signal into the formation;
receiving a current signal responsive to the induced electrical signal by at least one measure electrode placed in a pad disposed in the borehole; and
generating an impedance signal in response to the received current signal using a receiver circuit placed in the pad and coupled to the at least one measure electrode.

12. The method of claim 11 comprising processing the impedance signal to provide an estimate of the property of the formation.

13. The method of claim 12, wherein the property of the formation is resistivity of the formation.

14. The method of claim 11, wherein:
the at least one measure electrode comprises a plurality of measure electrodes; and
the receiver circuit comprises a separate gain/phase circuit associated with each measure electrode to provide the impedance signal corresponding to its associated measure electrode.

15. The method of claim 14, wherein each gain/phase circuit is an integrated circuit in the pad.

16. The method of claim 11, wherein inducing an electrical signal into the formation comprises inducing a voltage signal having a selected voltage and a selected frequency using at least one transmitter electrode.

17. The method of claim 11 further comprising digitizing the impedance signal using an analog-to-digital circuit placed in the pad.

18. The method of claim 11 wherein the impedance signal comprises a module signal and a phase signal and wherein the method further comprises processing the module signal and the phase signal to provide an image of a wall of the borehole.

19. The method of claim 11 further comprising using a downhole tool for estimating the property of the formation surrounding the borehole, wherein the downhole tool includes:
(i) a transmitter for inducing the electrical signal into the formation; and
(ii) an extendable arm for carrying the pad and to move the pad proximate a wall of the borehole.
